(19) United States
(12) Patent Application Publication
(10) Pub. No.: US 2015/0258593 A1
(43) Pub. Date: Sep. 17, 2015

(54) METHOD AND ASSEMBLY OF STRAIGHTENING HEAVY WALL TUBE

(71) Applicant: SSP Fittings Corp., Twinsburg, OH (US)

(72) Inventors: Jeffrey E. King, Hudson, OH (US); Paul J. Omilion, Walton Hills, OH (US); Jeffrey J. Smith, Ravenna, OH (US)

(73) Assignee: SSP Fittings Corp.

(21) Appl. No.: 14/658,700

(22) Filed: Mar. 16, 2015

Related U.S. Application Data
(60) Provisional application No. 61/954,041, filed on Mar. 17, 2014.
(60) Provisional application No. 62/060,190, filed on Oct. 6, 2014.

(51) Int. Cl. B21D 3/05; F16L 1/024; B21D 43/00

(52) U.S. Cl. CPC B21D 3/05; B21D 43/006; F16L 1/024

(57) ABSTRACT

An apparatus for straightening associated heavy wall tube provided in a coiled configuration at a worksite. The apparatus includes a frame that rotatably receives associated heavy wall tube in a coiled configuration. A straightener device has multiple rollers arranged so that tangents of the rollers receive the associated tube in a linear fashion between the rollers, none of the rollers being powered to rotate. A tube puller engages the tube adjacent a first end thereof, the tube puller moving relative to the frame for advancing the tube from the coiled configuration through the rollers of the straightener device. A truing device rounds the tube after the tube has left the straightener device, the truing device including multiple rollers and none of the rollers are powered.

### BACKGROUND

This application claims the priority benefit of U.S. provisional patent application Ser. Nos. 61/954,041, filed Mar. 17, 2014 and 62/060,190, filed Oct. 6, 2014, the disclosures of which are expressly incorporated herein by reference.

This disclosure relates to coiled tubing applications, and more particularly relates to an apparatus and method of straightening coiled tubing for end uses such as when constructing compressed natural gas (CNG) fueling stations, although one or more aspects of the present disclosure may find application in related environments and applications.

It is common when constructing a CNG fueling station, for example, to use metal tube or tubing. In order to maximize flow of compressed gas from compressors and/or storage cylinders out to dispensers for vehicle fueling, there is a desire to use tubing with ever-larger inner diameters. At the same time, metal tubing wall thickness must be sufficient to handle working pressures of the station, approximately 5500 psi. With ever-larger inner diameters, tubing outer diameters increase proportionally. The requirement to contain 5500 psi results in use of wall thicknesses considered “heavy wall” by industry. When using metal tubing that generally meet requirements of this type, it is common to use linear or straight lengths of tubing (e.g., twenty foot lengths) in which the ends of the tubing are then joined via welding operations with the next adjacent length of tubing. As will be appreciated, joining tube lengths in such a fashion requires a number of joints to be made up. Each joint must be prepared, welded, and inspected to be sure that it satisfies minimum quality control standards. This is a time-consuming and expensive process.

Using a continuous length of heavy walled tubing supplied from a coiled configuration or a spool would be ideal if the tubing could be effectively installed since such an arrangement would eliminate welding operations, inspections, etc. However, such a system or method has not heretofore been used at least in part because of the inability to uncoil or straighten on a job site the larger inner diameter, heavy wall tubing necessary for sufficient flow.

Thus a need exists for an improved apparatus and method of installing coiled tubing for such uses.

### BRIEF DESCRIPTION OF THE DRAWINGS

FIG. 1 is a schematic representation of an apparatus and method of supplying coiled tube at a job site.

FIG. 2 is a perspective view of another embodiment of an apparatus and associated method of straightening coiled tube at a job site.

FIG. 3 is a top plan view of FIG. 2.

FIG. 4 is a bottom plan view of FIG. 2.

FIG. 5 is a front, elevational view of the apparatus of FIG. 2.

FIG. 6 is a rear, elevational view of the apparatus of FIG. 2.

FIG. 7 is a side, elevational view of the apparatus taken generally from the right-hand side of FIG. 5.

FIG. 8 is a side, elevational view of the apparatus taken generally from the left-hand side of FIG. 5.

### DETAILED DESCRIPTION

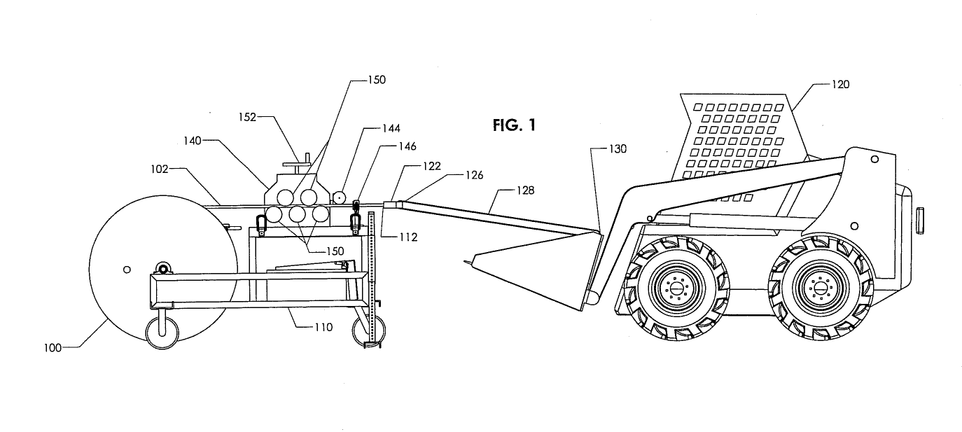

Turning first to FIG. 1, a spool 100 of coiled tube 102 is delivered to a job site. It is understood that the coiled tubing is capable of handling a predetermined pressure and flow, for instance greater than 5500 psi. In the CNG fueling station environment, it is common for the tubing 102 to be stainless steel tubing. For example, it is common to use seamless 316 stainless steel annealed tubing having an outer diameter of ½″, ¾″ or 1″ and average wall thickness ranging from 0.065 to 0.139 inches. This tubing is useful for both above-grade and below-grade applications.

Thus, spools 100 of coiled tube 102 may be easily delivered to a job site. The spool 100 of heavy walled stainless steel tubing 102 is preferably mounted on a support frame 110 so that a free end 112 of the tubing is aligned for connection with a tube puller. The support frame 110 may be configured for mobility (e.g., configured for lifting/transporting with a forklift, a lift assembly, lifted with straps, include wheels on at least one end to facilitate rolling, incorporate a lift jack at one end, etc.) More specifically, a common construction site vehicle 120 such as a skid steerer, loader/back-hoe, etc., is used as the motive power for pulling the free end 112 of the tube 102. More specifically, a tube pull adapter 122 is connected to the free end 112 of the tube 102. The adapter 122 may be a wedge-style gripper arrangement with the tube end 112 and in one preferred arrangement includes an opening 124, such as a clevis or eyebolt-type opening, that receives a first end 126 of a flexible lift strap 128. A second end 130 of the strap 128 is secured to the construction site vehicle 120. Of course connections other than the adapter and lift strap can be used to connect the free end 112 of the tube 102 to the tube puller 120.

Between the spool 100 and the adapter 122, the tubing 102 is fed through a straightener device 140, a counter 144, and tube support 146 such as a split guide bushing or similar support. Each of these components is preferably securely mounted to the support frame 110. The frame 110 may include wheels to assist in moving the frame around the job site, and likewise a leveling device or support jack at one end of the frame can be included to hold the support frame 110 in a desired job site location. As illustrated, the straightener device 140 includes multiple rolls or rollers 150 having recessed perimeter surfaces that are contoured to extend over a perimeter portion of the tubing and where the tangents of the rollers are positioned to receive the tubing 102 in a generally linear fashion therebetween. The relative position of the rollers 150 may be adjusted via adjustment mechanism 152 of the straightener device 140.

Once the tubing 102 has exited the straightener device 140, and once a predetermined length of tubing 102 has been straightened by the straightener device 140 and pulled from the spool 100 by the construction site vehicle 120 (as measured, for example, by the counter 144), the tubing is cut with a conventional tool (not shown). As will be appreciated, the newly cut end of the tubing can then be arranged for connection to the adapter 122 so that a new length of tubing 102 can be unwound from the spool 100, fed through the straightener device 140, and the tubing end connected to the tube puller or construction site vehicle 120 as described above.

The tube support 146 is preferably located at one end of the support frame 110. The tube support 146 provides a minimum friction surface, and cooperates with the counter 144 such as a roll footage counter received on the opposite side of the tubing 102 from the tube support. In this manner, an accurate measurement of the length of tubing 102 pulled by the construction site vehicle 120 from the spool 100, and through the straightener device 140 can be made. Roundness and surface finish of the tubing are important to ensure non-leak performance of the tube fitting connection. The present disclosure allows the tube to be easily straightened without deformation, elongation, or scarring of the outer diameter of the tube. The straightened tube may be used for a wide variety of end uses. For example, one intended use is to insert or feed extended lengths of tubing 102 into a protective sleeve or tube such as HDPE high density polyethylene conduit as is conventionally used in a CNG fueling station. However, the particular end use of the tube straightener assembly should not be deemed limiting to the present disclosure.

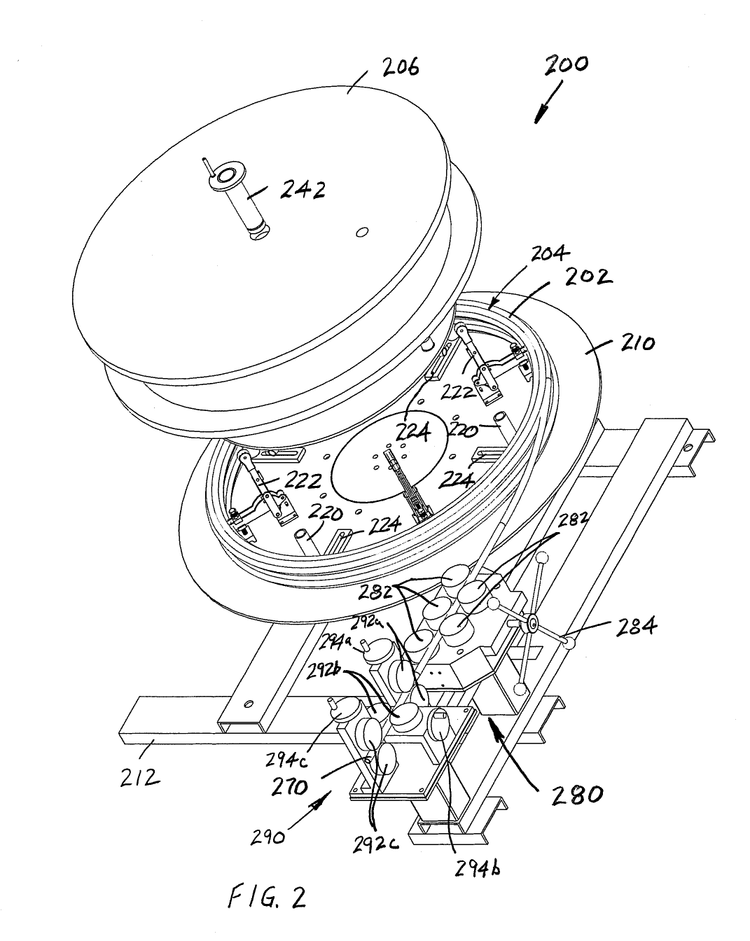

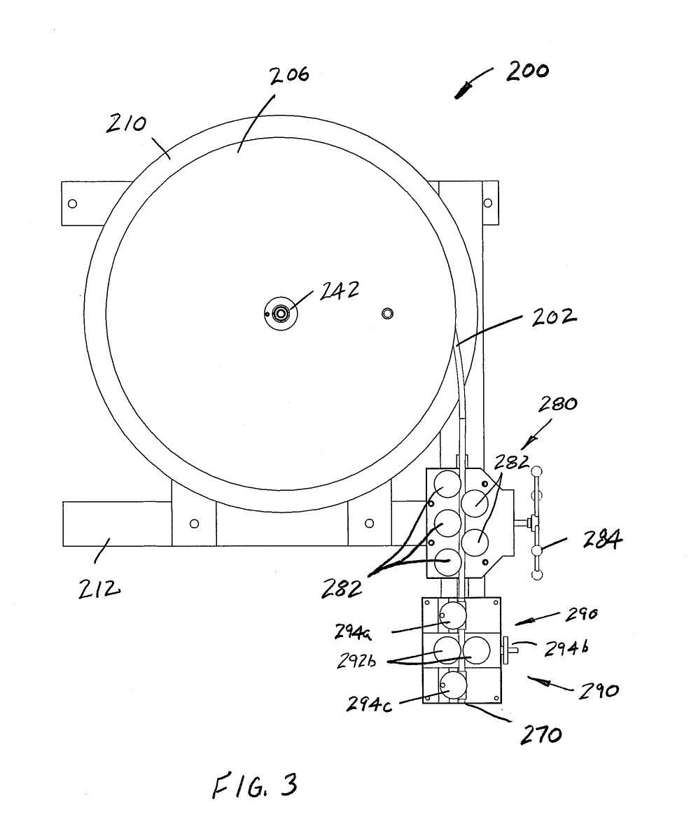

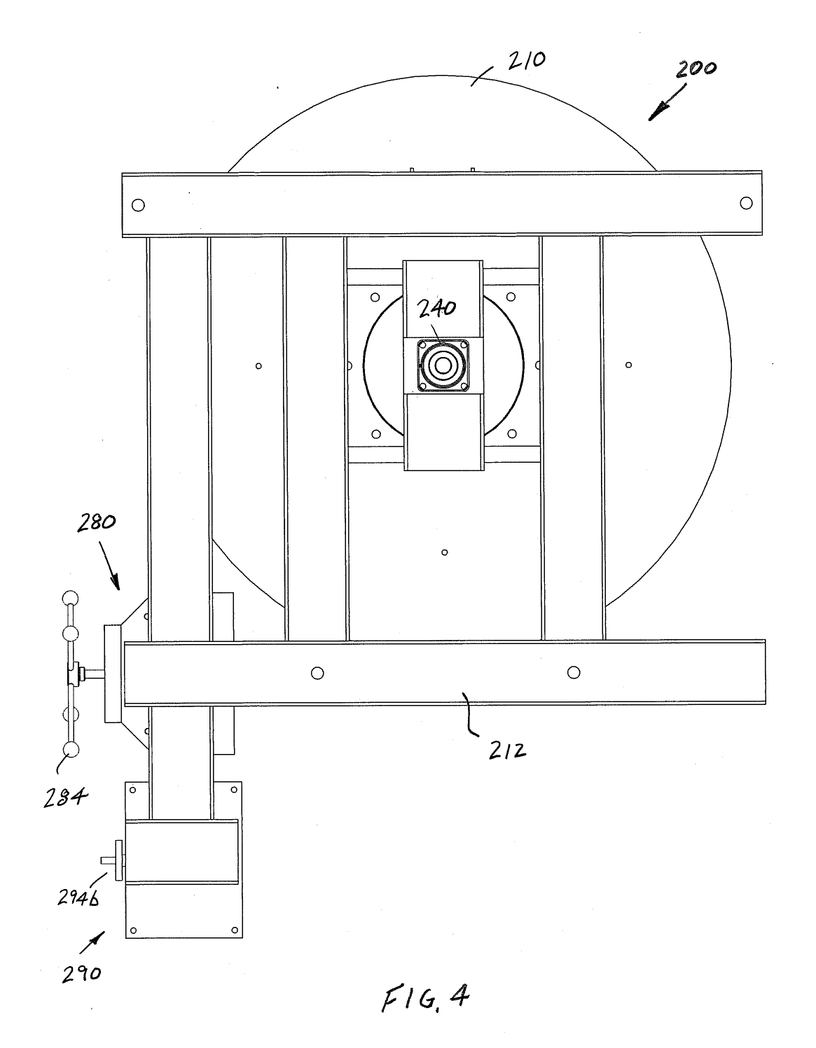

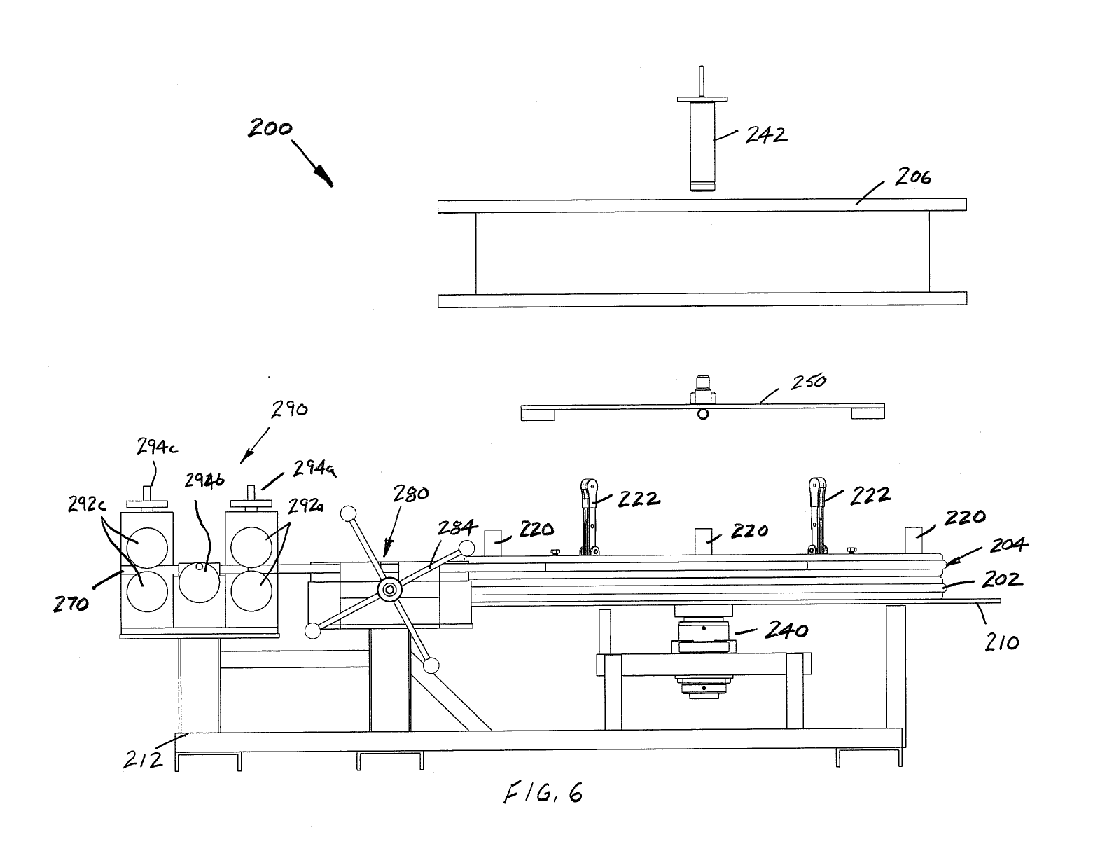

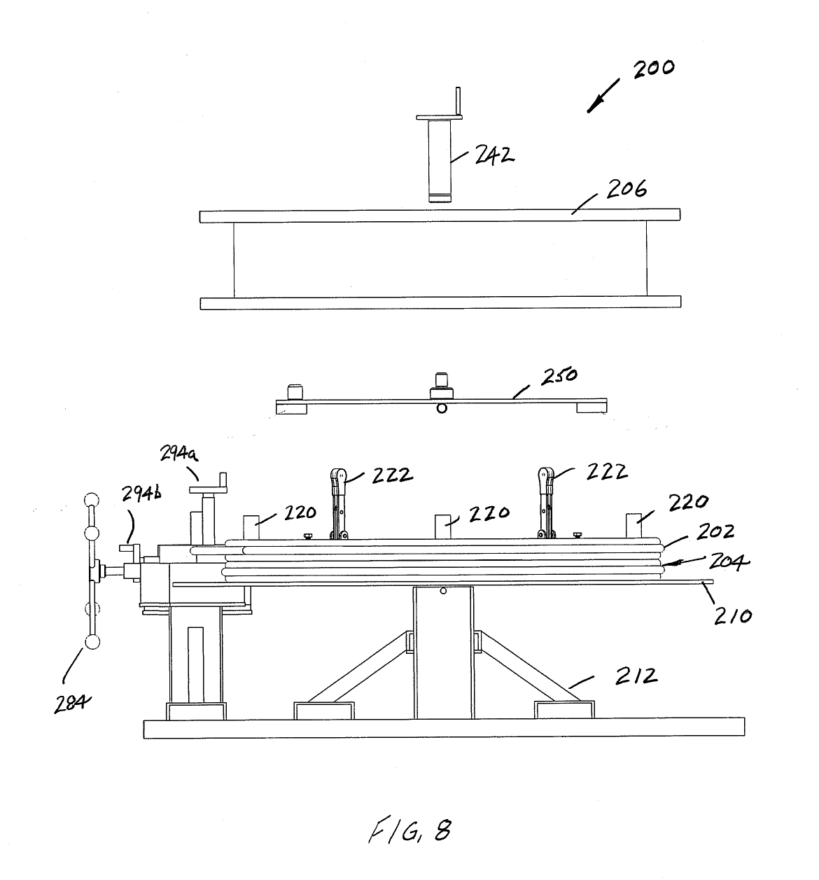

FIGS. 2-8 illustrate a second embodiment, and particularly an embodiment 200 used with heavy wall tube or tubing 202. In this arrangement 200, the tube 202 may be a seamless 316 stainless steel annealed structure having an outer diameter of approximately one inch (1″) (+0.005/−0.000) and a minimum wall thickness of 0.120 inches. As will be appreciated, it is known in the industry to use stainless steel tubing for a variety of end uses. When a tube reaches an outer diameter of one inch or greater, special arrangements must be made with a steel mill in order to obtain coiled tubing. That is, tubing of this diameter is typically formed in linear sections, e.g., twenty foot lengths, and opposite ends of the tube are then connected, i.e., welded, to an end of an adjacent tube. As noted in the Background, the straight lengths of tubing require that a number of joints be made, e.g., welded. Each joint must be prepared, welded, and inspected to be sure that the welded joint satisfies minimum quality control standards. As a result, installation may take many days or weeks in order to prepare the welds, weld the ends together, and await inspection. On the other hand, if continuous seamless tubing could be effectively used, a substantial amount of installation time, inspection time and associated cost can be eliminated.

Although the steel mill can form a continuous heavy wall tube (e.g., 1″ or greater) of extended length (e.g., 170 feet (170′)), transport of such an extended linear length is unfeasible. Therefore, the steel mill loosely coils the tubing 202. In other words, one inch or greater diameter tube 202 is typically not placed on a spool (as in the embodiment of FIG. 1), but rather is bent at the mill into a loosely coiled shape 204. The coil shape 204 allows the heavy wall tubing 202 of one inch or greater to be shipped to a job site. As will be further described below, there may be instances where special designed spools are created where 1 inch or greater coiled tube is level-wound on the custom spool. Consequently, straightener device 200 receives either loosely coiled tubing 202 or level-wound tubing received on a special built spool 206 (and the embodiment of FIGS. 2-8 illustrate both the loosely coiled tube and the spool with level-wound tubing to represent that either supply of coiled or would tubing can be accommodated by the tube straightener assembly).

At the job site, it becomes necessary to straighten the tubing 202 for the final end use. More particularly, the coil shape 204 is loaded onto a support or carousel 210 that has a diameter slightly greater than the coil shape in order to support the tubing 202 on the carousel. The carousel 210 has a substantially planar upper surface that is mounted on a rigid support frame 212. The frame may be easily transported to and from a job site, and once located, can be staked or otherwise secured against movement during use. As shown throughout these figures, the carousel 210 is adapted to receive either the loosely wound coil of tubing 202 or is adapted to receive the spool 206 with the level wound tubing previously wound thereon at the tubing manufacturer/supplier. The loosely wound coil 204 of tubing 202 would be secured to the carousel 210, for example, through use of support members or posts 220 and clamps or securing members 222 that secure and support the loosely wound coil on the upper surface of the carousel 210. Two or more support members or posts 220 extend outwardly, i.e., upwardly, from the surface 212 at locations spaced radially outward from a central axis or axis of rotation 216. Shown here are four posts 220 substantially equi-spaced about the carousel 210 and at substantially the same radius from the rotational axis of the carousel, although a greater or lesser number of posts may be used. The posts 220 are preferably mounted for limited radial movement or adjustment within respective slots 224 (FIG. 2) that extend in a substantially radial direction. In this manner, the coil shape 204 of extended length, heavy wall tubing 202 is placed/loaded onto the upper surface of the carousel 210 at the job site with the posts 220 typically initially positioned at radial innermost positions while the coil shape 204 is loaded on the carousel 210. The posts 220 are located within a central opening of the coil shape 204. At least one of the securing members 222 clamps a portion of the tubing 202 adjacent a first end and preferably each of the securing members will be used to clamp down peripheral portions of the first end of the tubing at circumferentially spaced locations on the surface of the carousel 210. The posts 220 are radially adjustable relative to the surface of the carousel 210 so that once the loosely wound coil 204 is received thereon, the posts are moved radially outward in their respective slots 224 into abutting engagement with the inner periphery or inner diameter of the loosely wound coil. Once the posts 220 are positioned at the desired location, the posts are tightened down relative to the surface of the carousel and serve to support the loosely wound coil of tubing 202 on the carousel 210.

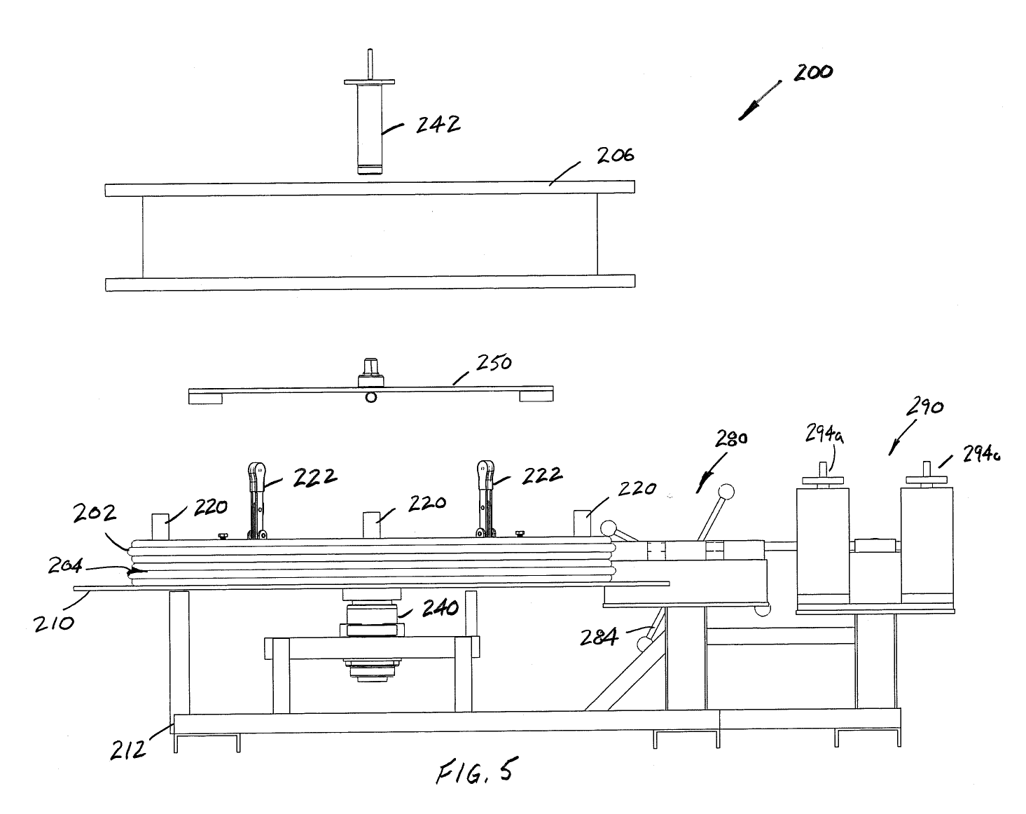

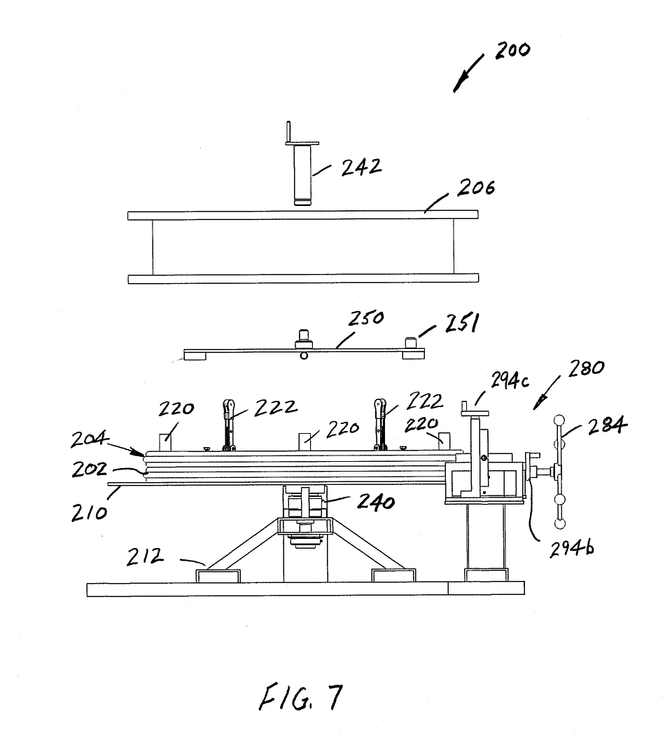

Alternatively, the carousel 210 is removed and the carousel table 250 is mounted to center hub 240, particularly around a support collar 242 that cooperates with the center hub to allow rotation of the carousel table 250 and spool 206 relative to the frame 212. The carousel table 250 (FIGS. 5-8) interconnects with the spool 206 via spool lock 251 (FIG. 7) to allow the two components to rotate together.

Next, a second end 270 of the tubing 202 is engaged with a tube pull adapter (not shown but similar to the adapter 122 of FIG. 1). For example, one preferred tube pull adapter is a wedge-style gripper arrangement that grasps the tube second end 270, and the adapter is in turn connected to a tube puller (not shown, but understood that a common construction site vehicle 240 such as a skid steerer, loader/backhoe, etc., is one type of tube puller that can be used as the motive power for pulling the free end 270 of the tube 202). It will also be appreciated that the arrangement could be modified or supplemented with a powered feed system such as a track drive, pinch rollers, or similar mechanism that either pushes or pulls the tubing 202 through/into a straightener device 280, although the straightener device is a non-powered set of rollers. As the second end 270 is pulled from the carousel 210 along a substantially tangential path, the tubing 202 is fed into the straightener device 280. The straightener device 280 is similar to that shown and described in connection with the embodiment of FIG. 1. For example, multiple rollers 282 are arranged to receive the tubing 202 in a generally linear fashion therebetween. The rollers 282 of the straightener device 280 may be adjusted via adjustment mechanism 284. The straightener device 280 receives the tubing therethrough, and particularly the second, free end 270 of the tubing 202 is fed tangentially from the coil 204 or spool 206. The series of rollers 282, for example five individual rollers, are part of the straightener device 280. The rollers 282 are non-powered, i.e. the tubing end 270 is fed linearly through the array of peripheral edges of the rollers where three rollers are received on one side of the tubing and a pair of rollers received on the other side of the tubing. The adjustment mechanism 284 allows the substantially linear passage between the rollers 282 to be adjusted if so desired.

Upon exiting the straightener device 280, the tubing 202 has been straightened. Thus, the tubing 202 may be straightened by pulling the tube second end 270 from the carousel 210 and through the straightener 280. As will be appreciated, as the pulling operation nears completion, and the first end of the tubing remains clamped to the carousel 210, it will be necessary to unclamp the tube first end from the carousel for passage through the straightener device 280.

Downstream of the straightener device 280 is provided a calibrating or truing device 290. The calibrating device 290 includes cooperating pairs of rollers 292a, 292b, 292c through which the tubing end 270 passes. Each pair of rollers includes a separate adjusting mechanism 294a, 294b, 294c that allows selective, separate alteration of the gap between the roller pair. After the previously coiled tubing has been straightened in the straightener device 280, the tubing may be out of round. If the tubing is substantially out of round, standard compression type fittings (not shown), for example, may not properly seal on the outer diameter tube. By providing the pairs of rollers 292a, 292b, 292c through which the tubing end 270 passes, the outer diameter of the tube is substantially encompassed and deformation that may occur in the outer diameter of the tube during the straightening process can be corrected by “truing” the outer diameter of the tube. Again, non-powered rollers 292 are preferred particularly since jobsites or worksites are often without power sources.

A primary benefit of the present disclosure relates to portability of the system. Another advantage resides in the fact that the tube can be fed without the use of a complex track feed, or a hydraulic pinch roller feed system requiring electricity and hydraulics. The complex track feed and hydraulic pinch roller feed system are customary feed mechanisms for wire and tube straightening in the industry that can be used if the worksite will accommodate powering such a system, but in other instances such track feed/pinch roller systems are not readily adaptable to on-site heavy walled tube straightening. As a consequence, it is important that the device be capable of straightening the heavy wall tubing without powered rollers.

As is evident, the continuous length of tubing can be effectively straightened. All of this can be achieved without electrical or hydraulic tooling required on-site, and a number of end-to-end welds are eliminated by use of an elongated, loosely coiled tubing or level-wound tubing on a spool that is subsequently straightened on-site. Moreover, one skilled in the art will recognize that the apparatus and method described herein with regard to one embodiment may also find application with smaller diameter tubes (e.g., as described in connection with FIG. 1) or with still other smaller or greater diameter tubing.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Moreover, this disclosure is intended to seek protection for a combination of components and/or steps and a combination of claims as originally presented for examination, as well as seek potential protection for other combinations of components and/or steps and combinations of claims during prosecution. For example, variations of this system can be used with any type of power feed for pushing or pulling the tube. Further, power assist if available at the work site may also be advantageously employed to close and open the roller mechanism. It is also contemplated that another set of rollers may be mounted in a plane perpendicular to the first set of rollers. The system is ideally collapsible and may also be permanently mounted to a trailer, truck, or the like for ease of transportation.

We claim:

1. An apparatus for straightening associated heavy wall tube provided in a coiled configuration at a worksite:
a frame that rotatably receives associated heavy wall tube in a coiled configuration;
a straightener device having multiple rollers arranged so that tangents of the rollers receive the associated tube in a linear fashion between the rollers; and
a tube puller that engages the associated tube adjacent a first end thereof, the tube puller moving relative to the frame for advancing the associated tube from the coiled configuration through the rollers of the straightener device.

2. The apparatus of claim 1 wherein none of the rollers is powered.

3. The apparatus of claim 1 wherein the coiled configuration of the tube is received on a spool that has an axis of rotation relative to the frame.

4. The apparatus of claim 3 wherein the axis of rotation is horizontal.

5. The apparatus of claim 3 wherein the axis of rotation is vertical.

6. The apparatus of claim 1 further comprising a jack/stand for adjusting a height of the associated tube exiting the straightener device.

7. The apparatus of claim 1 further comprising a fixing member for securing the frame from inadvertent movement at the worksite while straightening the tube.

8. The apparatus of claim 1 wherein the frame further includes a rotatable carousel that is dimensioned to receive the associated tube coil thereon.

9. The apparatus of claim 8 wherein the carousel includes at least one clamp for securing a second end of the associated tube to the carousel.

10. The apparatus of claim 9 further comprising at least one support post extending from the carousel at a location received within a central opening of the associated tube coil.

11. The apparatus of claim 10 wherein the at least one support post is adjustably mounted to the carousel.

12. The apparatus of claim 10 wherein the at least one support post includes plural support posts located at circumferentially spaced locations.

13. The apparatus of claim 1 further comprising a gripper/adapter for interfacing between an associated movable powered vehicle and engaging the first end of the associated tube.

14. The apparatus of claim 13 further comprising a lock member for securing the carousel against rotation during setup.

15. The apparatus of claim 1 further comprising a truing device for rounding the tube after the tube has left the straightener device.

16. An apparatus for straightening associated heavy wall tube provided in a coiled configuration at a worksite:
a frame that rotatably receives associated heavy wall tube in a coiled configuration;
a straightener device having multiple rollers arranged so that tangents of the rollers receive the associated tube in a linear fashion between the rollers, none of the rollers being powered to rotate; and
a tube puller that engages the associated tube adjacent a first end thereof, the tube puller moving relative to the frame for advancing the associated tube from the coiled configuration through the rollers of the straightener device.

17. The apparatus of claim 16 further comprising a truing device for rounding the tube after the tube has left the straightener device, the truing device including multiple rollers and none of the rollers are powered.

18. A process of straightening heavy wall tube provided in a coiled configuration at a worksite:
positioning a coiled configuration of the tube on a frame;
positioning the tube through a straightener device having multiple rollers arranged so that tangents of the rollers receive the tube in a linear fashion between the rollers; and
pulling a first end of the tube away from the frame and advancing the tube from the coiled configuration through the rollers of the straightener device.

19. The process of claim 18 further comprising providing only passive rollers on the straightener device.

20. The process of claim 18 further comprising adjusting a height of the associated tube exiting the straightener device.

21. The process of claim 18 further comprising securing the frame from inadvertent movement at the worksite while straightening the tube.

22. The process of claim 18 further comprising providing a rotatable carousel on the frame dimensioned to receive the tube coil thereon.

23. The process of claim 22 further comprising clamping a second end of the tube to the carousel.

24. The process of claim 23 further comprising providing at least one support post extending from the carousel at a location received within a central opening of the tube coil.

25. The process of claim 24 further comprising adjustably mounting the at least one support post to the carousel.

26. The process of claim 25 further comprising providing plural support posts at circumferentially spaced locations on the carousel.

27. The process of claim 22 further comprising securing the carousel against rotation during setup.

28. The process of claim 18 further comprising passing the tube through a calibrating/truing device downstream of the straightener device.

29. The process of claim 18 further comprising measuring a length of tube as the tube is straightened.

30. The process of claim 18 further comprising moving the frame from one job site to another.
